(19) United States
(12) Patent Application Publication
(10) Pub. No.: US 2010/0080676 A1
(43) Pub. Date: Apr. 1, 2010

(54) MANUFACTURING FACILITIES

(75) Inventors: Haruhiko Niitani, Ritto-shi (JP); Tsugumaru Yamashita, Ritto-shi (JP); Noritaka Fujimura, Ritto-shi (JP); Keiji Mizuta, Hiroshima-shi (JP)

Correspondence Address: BIRCH STEWART KOLASCH & BIRCH, PO BOX 747, FALLS CHURCH, VA, 22040-0747, US

(73) Assignee: MITSUBISHI HEAVY INDUSTRIES, LTD., Tokyo (JP)

(21) Appl. No.: 12/518,384

(22) PCT Filed: Nov. 16, 2007
(86) PCT No.: PCT/JP2007/072251

§ 371 Date: Jul. 30, 2009

(30) Foreign Application Priority Data
Dec. 18, 2006 (JP) 2006-339680

(51) Int. Cl. B23Q 41/02; B23Q 7/04; B23Q 7/14

(52) U.S. Cl. 414/226.01; 414/225.01

(57) ABSTRACT

Provided are manufacturing facilities capable of manufacturing many kinds of products efficiently in a small lot without increasing their cost. The manufacturing facilities comprise working cells (21 and 22) having at least two machine tools (11 and 12) arranged for working a workpiece (W), a rinsing cell (23) having at least two rinsing devices (13) arranged for rinsing the workpiece worked, an inspecting cell (24) having at least two inspecting devices (14) arranged for inspecting leakage of the workpiece rinsed, and a robot arm (15) capable of gripping the workpiece and transferring the workpiece between the individual cells (21, 22, 23 and 24). The individual cells (21, 22, 23 and 24) are arranged around the robot arm (15).

### TECHNICAL FIELD

This invention relates to manufacturing facilities.

### BACKGROUND ART

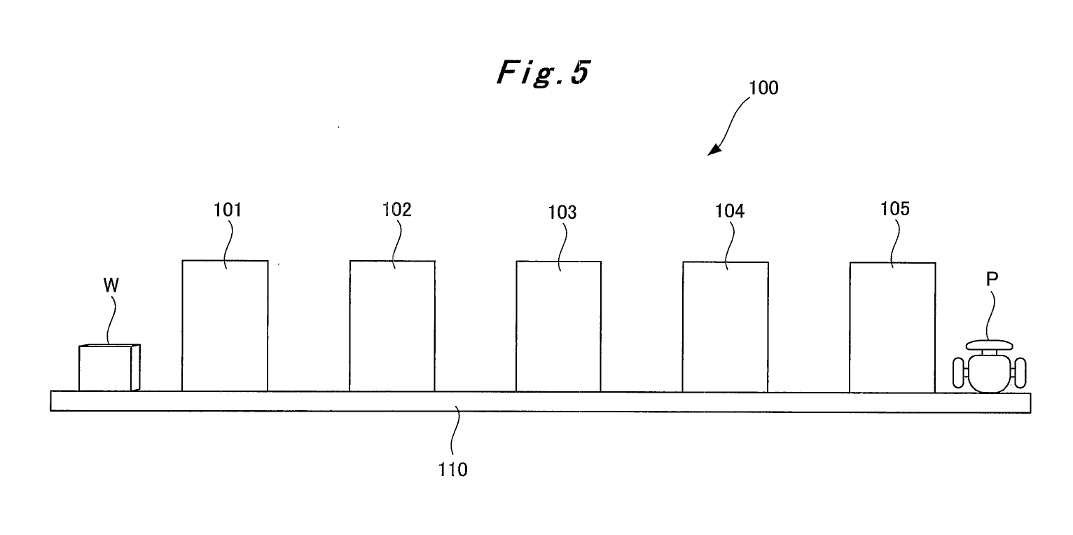

Manufacturing facilities 100 have so far comprised a roughing machine tool 101 for rough machining or roughing a workpiece W, a first rinsing device 102 for rinsing the roughed workpiece, a finishing machine tool 103 for finishing the rinsed workpiece, a second rinsing device 104 for rinsing the finished workpiece, an inspecting device 105 for inspecting the rinsed workpiece after finishing, and a transport device 110 for transporting the workpiece and transferring the workpiece W, as shown in FIG. 5. These machines and devices 101, 102, 103, 104 and 105 are arranged linearly, and the workpiece is transported by the transport device 110 sequentially to the adjacent machine or device after completion of operation in each step. By so doing, products of one kind have been mass-produced. In such manufacturing facilities 100, other machine tools or assembling machines have been arranged, as required, between the above devices or machines 101, 102, 103, 104 and 105, thereby dealing with the manufacture of various products. Furthermore, a plurality of the machines or devices have been provided in each step to construct a device group in each step, and these device groups have been arranged linearly along the transport device. Thus, the devices in the respective steps have been operated efficiently to enhance manufacturing efficiency.

Also, Patent Document 1 discloses a manufacturing system having an industrial robot and individual machine tools arranged such that the direction of transfer of work between the industrial robot and each machine tool is aligned with the horizontal direction, and a two-arm robot is used as the industrial robot. In this manner, the motions of the industrial robot are simplified, and the time required for handling of the work is shortened to increase manufacturing efficiency.

Patent Document 1: JP-A-2005-46966

### DISCLOSURE OF THE INVENTION

Problems to be Solved by the Invention

The above-described manufacturing facilities 100 shown in FIG. 5 can manufacture a single kind of product efficiently in large volume. If the size of the product, its material, or its working conditions are changed beyond a certain range (the tolerance range of the machine or device), however, the product cannot be manufactured, if the change remains as such, so that a new machine tool or the like has to be disposed in the manufacturing facilities 100. Moreover, such manufacturing facilities 100 are suitable for mass production of a single kind of product. If the volume of production is too low for the capacity of the facilities, therefore, spending on the facilities becomes excessive compared with the volume of production. Besides, if at least one of the above machines and devices 101, 102, 103, 104 and 105 fails, all of the manufacturing facilities 100 have to be stopped, leading to a decline in manufacturing efficiency. The arrangement of the respective machine and devices 101, 102, 103, 104 and 105 along the transport device has inhibited the downsizing of the transport device 110 or configurational changes.

Even the manufacturing system described in Patent Document 1 can efficiently manufacture a small number of types of products in high volume. However, if the size of the product, its material, or its working conditions are changed beyond a certain range (the tolerance range of the machine or device), this change, as such, cannot be dealt with, and a new machine tool or the like has to be disposed in the manufacturing system. Furthermore, such a manufacturing system is suitable for mass-producing a single kind of product. If the volume of production is too low for the capability of the manufacturing system, therefore, investment in the equipment of the manufacturing system becomes excessive compared with the volume of production. Besides, if at least one of the aforementioned machine tools fails, the entire manufacturing system has to be stopped, decreasing the manufacturing efficiency.

The present invention has been proposed in the light of the above-described situations. It is an object of the invention to provide manufacturing facilities capable of manufacturing many kinds of products efficiently in a small lot without increasing their cost.

Means for Solving the Problems

Manufacturing facilities according to the first aspect of the invention, intended for solving the above problems, comprise working cells having at least two machine tools arranged for working a workpiece, a rinsing cell having at least two rinsing devices arranged for rinsing the workpiece worked, an inspecting cell having at least two inspecting devices arranged for inspecting the leakage of the workpiece, and a robot arm capable of gripping the workpiece and transferring the workpiece between the individual cells, the individual cells being arranged around the robot arm.

Manufacturing facilities according to the second aspect of the invention, intended for solving the above problems, are the manufacturing facilities according to the first aspect of the invention, characterized in that an assembly cell having at least two assembling devices for assembling the workpiece is further arranged around the robot arm.

Manufacturing facilities according to the third aspect of the invention, intended for solving the above problems, are the manufacturing facilities according to the first or second aspect of the invention, characterized in that the individual cells are arranged radially about the robot arm as a center.

Manufacturing facilities according to the fourth aspect of the invention, intended for solving the above problems, are the manufacturing facilities according to any one of the first to third aspects of the invention, characterized in that a plurality of the robot arms are provided.

Effects of the Invention

The manufacturing facilities according to the present invention comprise working cells having at least two machine tools arranged for working a workpiece, a rinsing cell having at least two rinsing devices arranged for rinsing the workpiece worked, an inspecting cell having at least two inspecting devices arranged for inspecting the leakage of the workpiece, and a robot arm capable of gripping the workpiece and transferring the workpiece between the individual cells, the individual cells being arranged around the robot arm. Thus, there is no need to move the robot arm itself, and only the operation by the robot arm for transferring the workpiece is performed. Hence, the transport time for the workpiece can be shortened, and the manufacturing efficiency can be increased. Furthermore, the moving Hi stance of the workpiece can be shortened, and the manufacturing speed can be increased. The device used in each cell can be set, as appropriate, in accordance with changes in the size of the product, its material, the manufacturing conditions, etc. Thus, many kinds of products can be manufactured efficiently in a small lot.

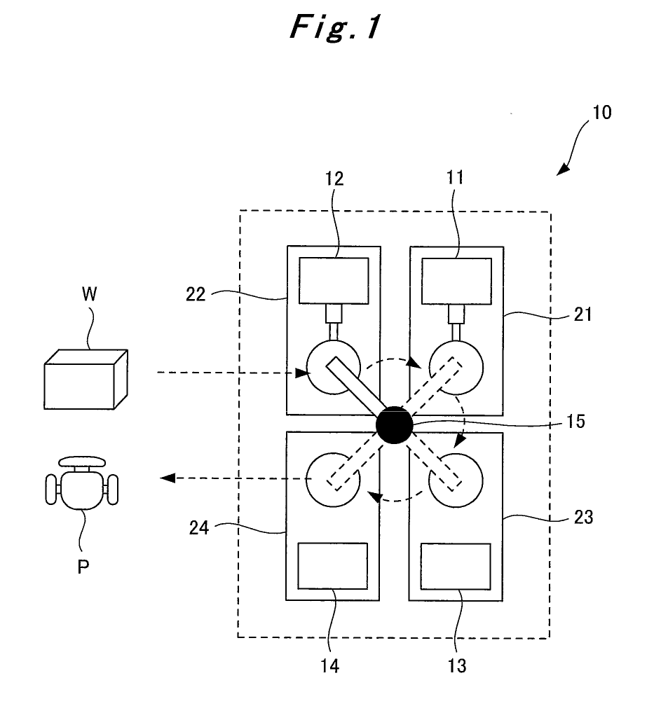

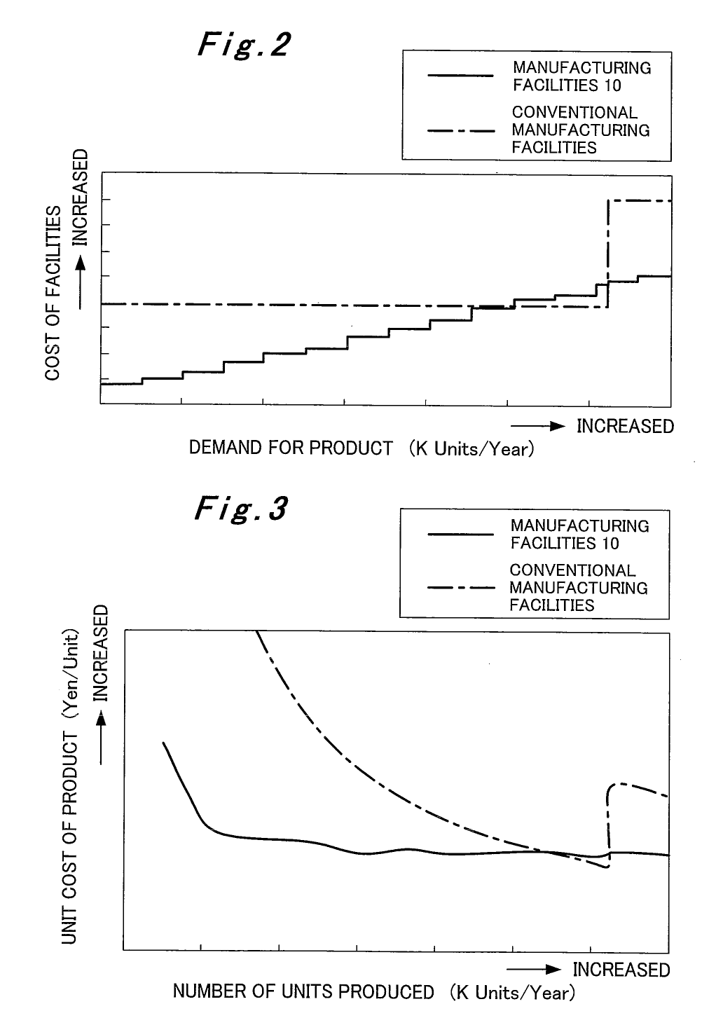

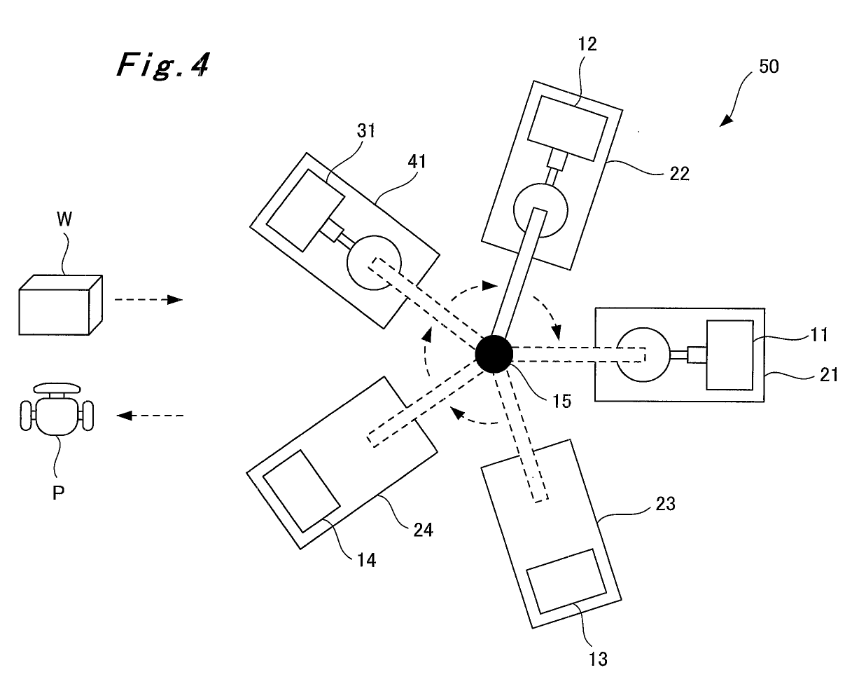

### BRIEF DESCRIPTION OF THE DRAWINGS

[FIG. 1] is a schematic view of manufacturing facilities according to the best embodiment of the present invention.

[FIG. 2] is a graph showing the relationship between the demand for product and the cost of facilities in the manufacturing facilities according to the best embodiment of the present invention and conventional manufacturing facilities. [FIG. 3] is a graph showing the relationship between the number of units produced and the unit cost of product in the manufacturing facilities according to the best embodiment of the present invention and the conventional manufacturing facilities.

[FIG. 4] is a schematic view of manufacturing facilities according to another embodiment of the present invention.

[FIG. 5] is a schematic view of the conventional manufacturing facilities.

### DESCRIPTION OF THE NUMERALS AND SYMBOLS

10, 50 manufacturing facilities, 11 first machine tool, 12 second machine tool, 13 rinsing device, 14 inspecting device, 15 robot arm, 21 first working cell, 22 second working cell, 23 rinsing cell, 24 inspecting cell, 31 assembling device, 41 assembling cell, P product, W workpiece.

### BEST MODE FOR CARRYING OUT THE INVENTION

Hereinbelow, the best mode for putting the manufacturing facilities according to the present invention into practice will be described.

FIG. 1 is a schematic view of manufacturing facilities according to the best embodiment of the present invention. FIG. 2 is a graph showing the relationship between the demand for product and the cost of facilities in the manufacturing facilities according to the best embodiment of the present invention and conventional manufacturing facilities. FIG. 3 is a graph showing the relationship between the number of units produced and the unit cost of product in the manufacturing facilities according to the best embodiment of the present invention and the conventional manufacturing facilities. In FIGS. 2 and 3, the solid line represents the manufacturing facilities according to the best embodiment of the present invention, while the dashed dotted line represents the conventional manufacturing facilities.

Manufacturing facilities 10 according to the best embodiment of the present invention comprise working cells 21 and 22 having at least two machine tools arranged for working a workpiece W, a rinsing cell 23 having at least two rinsing devices 13 arranged for rinsing the workpiece worked, an inspecting cell 24 having at least two inspecting devices 14 arranged for inspecting the leakage of the rinsed workpiece, and a robot arm 15 capable of gripping the workpiece and transferring the workpiece between the individual cells 21, 22, 23 and 24, and the individual cells 21, 22, 23 and 24 are arranged around the robot arm 15. However, the robot arm 15 reaches the worktables of the individual cells 21, 22, 23 and 24, performs setup and changeover for the workpiece W between the individual cells 21, 22, 23 and 24, and delivers a product P.

The above-mentioned machine tools comprise a first machine tool 11 for roughing the workpiece, and a second machine tool 12 for finishing the workpiece. The machine tools 11 and 12 have inspecting functions of inspecting the worked site of the workpiece.

A process for manufacturing the product P from the workpiece W in the foregoing manufacturing facilities 10 will be described below.

First of all, when the workpiece W is carried into the manufacturing facilities 10, the workpiece W is transferred to the first machine tool 11 of the first working cell 21 by the robot arm 15. Upon completion of roughing of the workpiece W by the first machine tool 11, the roughed workpiece W is transferred to the rinsing device 13 of the rinsing cell 23 by the robot arm 15. When rinsing of the workpiece W by the rinsing device 13 is completed, the rinsed workpiece W is transferred to the second machine tool 12 of the second working cell 22 by the robot arm 15. Upon completion of finishing by the second machine tool 12, the finished workpiece W is transferred to the rinsing device 13 of the rinsing cell 23 by the robot arm 15. When rinsing of the workpiece W by the rinsing device 13 is completed, the rinsed workpiece W is transferred to the inspecting device 14 of the inspecting cell 24 by the robot arm 15. When inspection for leakage of the rinsed workpiece W by the inspecting device 14 is completed, the inspected workpiece W is transferred to the robot arm 15, and carried as the product P out of the manufacturing facilities 10. As the product P, various mass-produced metal components, such as a cylinder head and a cylinder block, are named.

[Evaluation]

The above-described manufacturing facilities 10, and the conventional manufacturing facilities having the same devices as in the manufacturing facilities 10 arranged linearly were evaluated for the relationship between a demand for the workpiece and the cost of facilities, and for the relationship between the number of units produced and the unit cost of the product.

As shown in FIG. 2, it turned out that with the aforementioned manufacturing facilities 10, the cost of the facilities increased in proportion to an increase in the number of demands for the workpiece; whereas with the conventional manufacturing facilities, the cost of the facilities was constant until the number of demands for the workpiece reached a predetermined amount and, when this predetermined amount was exceeded, the cost of the facilities increased and became constant again. As shown in FIG. 3, moreover, with the aforementioned manufacturing facilities 10, the unit cost of the product was a predetermined value, even when the number of units produced was small as compared with the conventional manufacturing facilities. It was found, therefore, that the conventional manufacturing facilities were suitable for mass production of a single kind of product, but were not suitable for low-volume production of many kinds of products, whereas the aforementioned manufacturing facilities 10 were suitable for low-volume production of many kinds of products.

Hence, according to the manufacturing facilities 10 concerned with the best embodiment of the present invention, the individual cells 21, 22, 23 and 24 are arranged around the robot arm 15 as a center, so that it is not necessary to move the robot arm 15 itself, and it suffices to perform an operation for transferring the workpiece W by the robot arm 15. Thus, the transport time for the workpiece W and the time for setup and changeover can be shortened to enhance the manufacturing efficiency. Furthermore, the moving distance of the workpiece W can be shortened to increase the manufacturing speed. The devices 11, 12, 13 and 14 used in the individual cells 21, 22, 23 and 24 can be set, as appropriate, in accordance with changes in the size of the product P, its material, the manufacturing conditions, etc., and many kinds of products P can be manufactured efficiently in a small lot. Fluctuations in the volume of production due to a failure in any one of the devices 11, 12, 13 and 14 are the only fluctuations in the volume of production associated with the devices, so that fluctuations in the volume of production in the manufacturing facilities 10 can be diminished in comparison with fluctuations in the volume of production in the conventional manufacturing facilities. In the event of a defective unit occurring, it is easy to pinpoint the device which has caused the defective unit, thus enabling maintainability to be enhanced. Moreover, work loads on the respective devices 11, 12, 13 and 14 of the individual cells 21, 22, 23 and 24 can be rendered equal. Consequently, the timing of transferring the workpiece W between the respective devices 11, 12, 13 and 14 can be adjusted, and the occurrence of a waiting time for operation in the respective devices 11, 12, 13 and 14 can be curbed to increase the manufacturing efficiency.

Beside, the machine tools are provided which consist of the first machine tool 11 for roughing and the second machine tool 12 for finishing. Thus, the working time in each step can be shortened to increase working efficiency, enhancing the manufacturing efficiency of the product P.

In the foregoing, the manufacturing facilities 10 having the individual devices 11, 12, 13 and 14 simply arranged around the robot arm 15 as a center are used for explanation. As shown in FIG. 4, however, an assembling cell 41 having at least one assembling device 31 for assembling the workpiece may be further disposed in the manufacturing facilities 10, around the robot arm 15 as a center, and the individual cells 21, 22, 23, 24 and 41 may be radially arranged about the robot arm 15 as the center to construct manufacturing facilities 50. Such manufacturing facilities 50 not only exhibit the same actions and effects as those of the manufacturing facilities 10 according to the aforementioned best embodiment of the present invention, but can also shorten the time for transfer of the workpiece W by the robot arm 15, and further enhance manufacturing efficiency.

In the foregoing, the manufacturing apparatus 10 equipped with the one robot arm 15 is used for explanation. However, the manufacturing facilities may have a plurality of the robot arms. Even such manufacturing facilities not only exhibit the same actions and effects as those of the manufacturing facilities 10 according to the aforementioned best embodiment of the present invention, but can also avoid the interference of the robot arms, thereby further shortening the transport time for the workpiece W, and further enhancing manufacturing efficiency.

In the foregoing, the manufacturing facilities 10 having two of the individual devices 11, 12, 13 and 14 are used for explanation. However, the manufacturing facilities 10 may have a plurality of, i.e., three or more of, the individual devices 11, 12, 13 and 14. Even such manufacturing facilities not only exhibit the same actions and effects as those of the manufacturing facilities 10 according to the aforementioned best embodiment of the present invention, but can also manufacture many kinds of products in low volume. That is, with such manufacturing facilities, the machines, etc. operated in conformity with the products can be selected. Thus, manufacturing efficiency can be enhanced.

In the foregoing, the manufacturing facilities 10 as a single entity are used for explanation. However, the manufacturing facilities may be constituted as a plurality of the manufacturing facilities 10 arranged. Even such manufacturing facilities exhibit the same actions and effects as those of the manufacturing facilities 10 according to the aforementioned best embodiment of the present invention.

### INDUSTRIAL APPLICABILITY

The present invention can be utilized as manufacturing facilities equipped with machine tools for cutting various mass-produced metal components for internal combustion engines, etc.

1-4. (canceled)

5. Manufacturing facilities, comprising:
working cells having at least two machine tools arranged for working a workpiece;
a rinsing cell having at least two rinsing devices arranged for rinsing the workpiece worked;
an inspecting cell having at least two inspecting devices arranged for inspecting leakage of the workpiece: and
a robot arm capable of gripping the workpiece and transferring the workpiece between the cells,
the cells being arranged around the robot arm.

6. The manufacturing facilities according to claim 5, characterized in that
an assembly cell having at least two assembling devices for assembling the workpiece is further arranged around the robot arm.

7. The manufacturing facilities according to claim 5, characterized in that
the cells are arranged radially about the robot arm as a center.

8. The manufacturing facilities according to claim 6, characterized in that
the cells are arranged radially about the robot arm as a center.

9. The manufacturing facilities according to claim 5, characterized in that
a plurality of the robot arms are provided.

10. The manufacturing facilities according to claim 6, characterized in that
a plurality of the robot arms are provided.

11. The manufacturing facilities according to claim 7, characterized in that
a plurality of the robot aims are provided.

12. The manufacturing facilities according to claim 8, characterized in that
a plurality of the robot arms are provided.
